(19) United States
(12) Patent Application Publication
(10) Pub. No.: US 2017/0333927 A1
(43) Pub. Date: Nov. 23, 2017

(54) PLURAL COMPONENT DISPENSING SYSTEM

(71) Applicant: Graco Minnesota Inc., Minneapolis, MN (US)

(72) Inventors: Daniel P. Ross, Vadnais Heights, MN (US); Joseph E. Tix, Hastings, MN (US); Martin P. McCormick, Forest Lake, MN (US); Mark T. Weinberger, Mounds View, MN (US); Robert J. Lind, Robbinsdale, MN (US)

(21) Appl. No.: 15/592,906

(22) Filed: May 11, 2017

Related U.S. Application Data
(60) Provisional application No. 62/338,131, filed on May 18, 2016.

(51) Int. Cl. B05B 7/00; B05B 7/26; B05B 9/04; B05B 12/08

(52) U.S. Cl. CPC B05B 7/0018; B05B 12/087; B05B 7/26; B05B 9/0403

(57) ABSTRACT

First and second fluid components are individually pumped to a device from first and second pumps. A first volumetric flow rate of the first fluid component discharged from the first fluid component is measured. A second volumetric flow rate of the second fluid component discharged from the second pump is measured. Operation of at least one of the first and second pumps is controlled based on the measured first volumetric flow rate and the measured second volumetric flow rate to produce a target ratio of the first fluid component and the second fluid component at the device.

### CROSS-REFERENCE TO RELATED APPLICATION(S)

This application claims priority to U.S. Provisional Application No. 62/338,131, filed on May 18, 2016, and entitled “VOLUMETRIC FOAM METERING,” the disclosure of which is hereby incorporated by reference in its entirety.

### BACKGROUND

This disclosure relates generally to plural component dispensing systems, and more particularly to monitoring and control of the plural material components to achieve a target mixing ratio.

Multiple component (e.g., fluid) applicators often include dispensing systems that receive separate inert material components, mix the components in a predetermined ratio, and then dispense the components as an activated compound. For example, multiple component applicators are often used to dispense epoxies and polyurethanes that solidify after mixing of a resin component and an activating material, which are individually inert. After mixing, an immediate chemical reaction begins that results in the cross-linking, curing, and solidification of the mixture. Therefore, the two components are routed separately in the system so that they can remain segregated as long as possible. A dispensing device, such as a sprayer or other device, receives each component after it is pumped separately and mixes the components for delivery as an activated compound.

A typical multiple component applicator system includes positive displacement pumps that individually draw in material from separate hoppers and pump pressurized materials (e.g., fluids) to the dispensing device for mixing and application. The pumps are often driven in synchronicity by a common motor, typically an air motor, electric motor/drive, or hydraulic motor, having a reciprocating drive shaft or rotary output for pumps such as gear pumps. In some examples, unequal ratios of the material components can be achieved using multiple pumps, each having different volumetric displacements. In such examples, each of the pumps is typically driven by a common motor in synchronicity, and the target ratio of the components is achieved through the use of appropriately sized pumps having different volumetric displacements. The use of such systems (i.e., having multiple pumps controlled via a single motor) precludes the use of the pumps for applications requiring a component ratio other than that which the pumps are sized to accommodate. Moreover, control of the multiple pumps via the single motor hinders the ability of the system to compensate for pump performance degradation or other system variations that can result in variation of the flow rates of one or more of the components delivered to the dispensing device.

### SUMMARY

In one example, a system includes a first pump for delivering a first fluid component, a second pump for delivering a second fluid component, a first flow meter, a second flow meter, a device for receiving the first fluid component and the second fluid component, and a controller. The first flow meter is configured to sense a first volumetric flow rate of the first fluid component delivered from the first pump. The second flow meter is configured to sense a second volumetric flow rate of the second fluid component delivered from the second pump. The controller is connected to receive the sensed first volumetric flow rate from the first flow meter and the sensed second volumetric flow rate from the second flow meter. The controller is configured to control operation of at least one of the first pump and the second pump based on the sensed first volumetric flow rate and the sensed second volumetric flow rate to produce a target ratio of the first fluid component and the second fluid component at the device.

In another example, a method includes pumping a first fluid component to a dispensing device from a first pump, pumping a second fluid component to the dispensing device from a second pump, measuring a first volumetric flow rate of the first fluid component discharged from the first pump, and measuring a second volumetric flow rate of the second fluid component discharged from the second pump. The method further includes controlling operation of at least one of the first pump and the second pump based on the measured first volumetric flow rate and the measured second volumetric flow rate to produce a target ratio of the first fluid component and the second fluid component at the dispensing device.

### BRIEF DESCRIPTION OF THE DRAWINGS

FIG. 1 is a schematic block diagram of one example of a plural component fluid dispensing system that controls operation of at least one of a first pump and a second pump to produce a target ratio of the fluid components.

FIG. 2 is a schematic block diagram of another example of a plural component fluid dispensing system that controls operation of at least one of a first pump and a second pump to produce a target ratio of the fluid components.

### DETAILED DESCRIPTION

As described herein, a plural component dispensing system controls operation of at least one of a first pump and a second pump based on sensed volumetric flow rates from each of the first and second pumps to achieve a target ratio of the components. Accordingly, techniques of this disclosure help to ensure that the individual components are applied at the target ratio. Moreover, a system implementing techniques described herein can be utilized to supply varying ratios of the multiple components without requiring redesign and replacement of the pumps to achieve the varying component ratios.

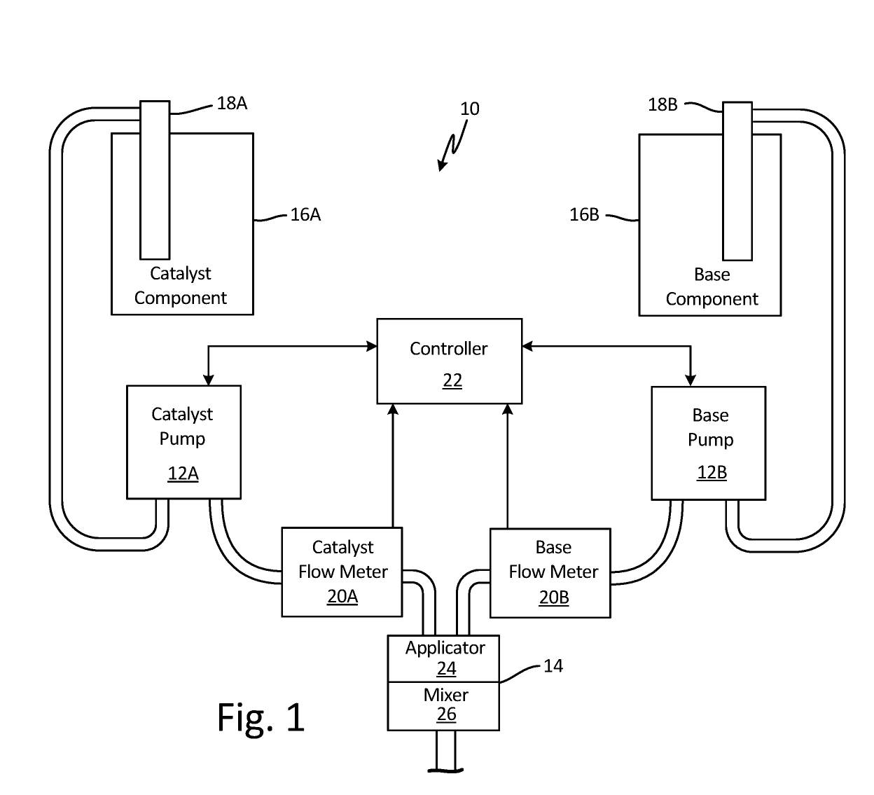

FIG. 1 is a schematic block diagram of fluid dispensing system 10 that controls operation of at least one of catalyst pump 12A and base pump 12B to produce a target ratio of a catalyst material component and a base material component at dispensing device 14. As illustrated in FIG. 1, fluid dispensing system 10 further includes catalyst component vessel 16A, base component vessel 16B, catalyst transfer pump 18A, base transfer pump 18B, catalyst flow meter 20A, base flow meter 20B, and controller 22. Dispensing device 14 includes applicator 24 and mixer 26.

Catalyst component vessel 16A stores a catalyst material (e.g., fluid) component. Base component vessel 16B stores a base material (e.g., fluid) component. The catalyst material component and base material component are separately-inert components in a two-component spray application in which the catalyst material component and the base material component chemically react when mixed to form an activated material, such as quick-cure polyurethane foam.

Each of catalyst transfer pump 18A and base transfer pump 18B are a positive displacement or other type of pump configured to deliver a respective one of the catalyst material component and the base material component under pressure to catalyst pump 12A and base pump 12B. That is, as illustrated in FIG. 1, catalyst transfer pump 18A is connected to catalyst pump 12A to deliver catalyst material component from catalyst component vessel 16A to catalyst pump 12A. Base transfer pump 18B is connected to base pump 12B to deliver base material component from base component vessel 16B to base pump 12B. Each of catalyst transfer pump 18A and base transfer pump 18B are, in some examples, low pressure transfer pumps configured to deliver material component at a first pressure (e.g., 200 psi) to a respective one of catalyst pump 12A and base pump 12B which deliver the respective material component to dispensing device 14 at a substantially higher pressure, such as 2000 psi.

Catalyst pump 12A and base pump 12B are positive displacement pumps, such as rotary gear pumps, piston pumps, screw pumps, pressure pumps, or other types of pumps. In the example of FIG. 1, catalyst pump 12A and base pump 12B are connected to receive the catalyst material component (i.e., catalyst pump 12A) from catalyst transfer pump 18A and the base material component (i.e., base pump 12B) from base transfer pump 18B. Catalyst pump 12A and base pump 12B are each connected to deliver a respective one of catalyst material component and base material component under pressure to dispensing device 14.

Catalyst flow meter 20A is located between catalyst pump 12A and dispensing device 14 to measure a volumetric flow rate of catalyst material component discharged from catalyst pump 12A to dispensing device 14 as it passes through catalyst flow meter 20A. Base flow meter 20B is located between base pump 12B and dispensing device 14 to measure a volumetric flow rate of base material component discharged from base pump 12B to dispensing device 14 as it passes through base flow meter 20B. Each of catalyst flow meter 20A and base flow meter 20B can be a positive displacement meter (e.g., gear meter), mass flow meter, or other type of flow meter. Catalyst flow meter 20A and base flow meter 20B can be the same or different type of flow meter. In general, each of catalyst flow meter 20A and base flow meter 20B can be any type of flow meter configured to measure a volumetric flow rate of material component passing through the respective flow meter and transmit an indication of the sensed volumetric flow rate to controller 22. That is, as illustrated in FIG. 1, each of catalyst flow meter 20A and base flow meter 20B are electrically and/or communicatively coupled with controller 22 to transmit an indication of a sensed volumetric flow rate to controller 22 during operation. Controller 22 utilizes the received volumetric flow rates to control operation of at least one of catalyst pump 12A and base pump 12B to achieve a target ratio of catalyst material component and base material component delivered to dispensing device 14, as is further described below.

Dispensing device 14, as illustrated in FIG. 1, includes applicator 24 and mixer 26. Dispensing device 14 can be, e.g., a dispensing gun configured to receive the individually-inert catalyst and base material (e.g., fluid) components and deliver the activated compound after mixing of the catalyst and base material component at mixer 26. That is, applicator 24 receives each of the catalyst material component and the base material component and provides the two individual components to mixer 26, which mixes the two components during delivery. Accordingly, mixing of the base material component and the catalyst material component is delayed until delivery of the components through mixer 26 and release of the activated material from dispensing device 14.

Controller 22 includes one or more processors and computer-readable memory encoded with instructions that, when executed by the one or more processors, cause controller 22 to operate in accordance with techniques described herein. Examples of the one or more processors include any one or more of a microprocessor, a digital signal processor (DSP), an application specific integrated circuit (ASIC), a field-programmable gate array (FPGA), or other equivalent discrete or integrated logic circuitry. Computer-readable memory of controller 22 can be configured to store information within controller 22 during operation. The computer-readable memory can be described, in some examples, as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). Computer-readable memory of controller 22 can include volatile and non-volatile memories. Examples of volatile memories can include random access memories (RAM), dynamic random access memories (DRAM), static random access memories (SRAM), and other forms of volatile memories. Examples of non-volatile memories can include magnetic hard discs, optical discs, floppy discs, flash memories, or forms of electrically programmable memories (EPROM) or electrically erasable and programmable (EEPROM) memories.

Controller 22, in some examples, includes user interface components including one or more input devices (e.g., a keyboard, buttons, mouse, microphone, or other input devices) configured to receive input from a user, and one or more output devices (e.g., a display device, indicator lights, or other output devices) configured to present information to a user. In some examples, controller 32 includes a touch-sensitive display configured to receive user input in the form of gestures (e.g., touch gestures, swipe gestures, pinch gestures, or other gestures) and to display information to the user. Controller 22, in certain examples, receives user input defining a target ratio (e.g., a target mixing ratio) of catalyst material component and base material component to be delivered to dispensing device 14.

As illustrated in FIG. 1, controller 22 is electrically and/or communicatively coupled with each of catalyst flow meter 20A and base flow meter 20B to receive information indicative of a sensed volumetric flow rate measured by each of catalyst flow meter 20A and base flow meter 20B. For instance, in examples where catalyst flow meter 20A and base flow meter 20B are positive displacement gear meters, controller 22 can receive an indication of a number of gear revolutions of each of catalyst flow meter 20A and base flow meter 20B. In such examples, controller 22 can determine a volumetric flow rate through each respective flow meter based on a defined volumetric flow per revolution (or partial revolution) of the respective gears. In other examples, one or more of catalyst flow meter 20A and base flow meter 20B can determine a volumetric flow rate through the respective flow meter and can transmit an indication of the measured volumetric flow rate to controller 22.

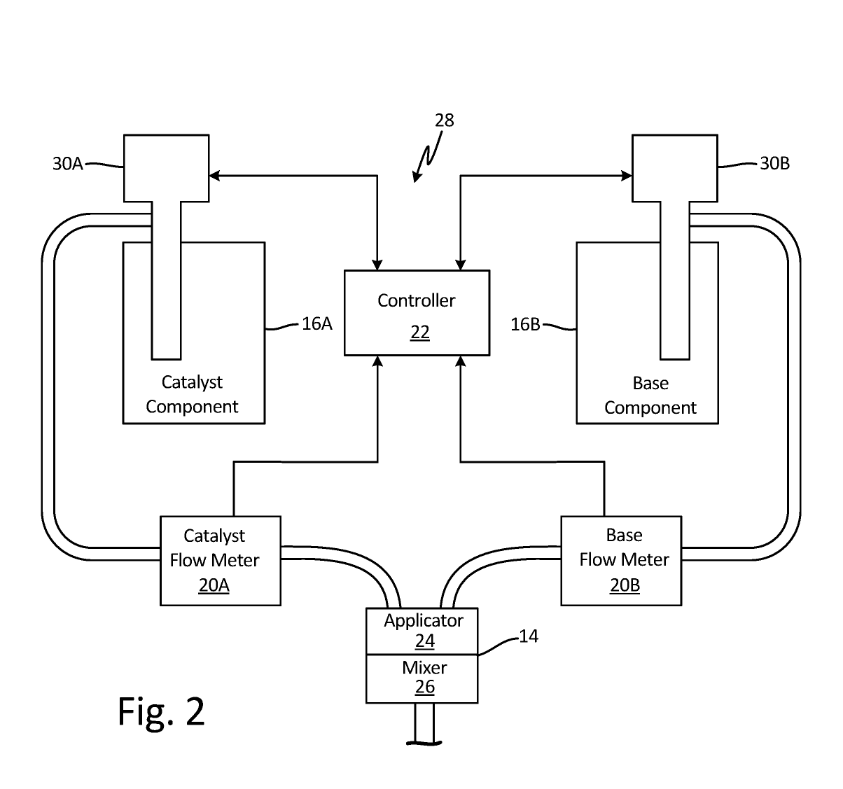

Controller 22, as illustrated in FIG. 2, is electrically and/or communicatively coupled with each of catalyst pump 12A and base pump 12B. Controller 22 controls operation of one or more of catalyst pump 12A and base pump 12B based on the measured volumetric flow rates of catalyst material component and base material component received from catalyst flow meter 20A and base flow meter 20B, respectively, to produce a target ratio of the catalyst material component and base material component at dispensing device 14. For example, controller 22 can store the target ratio and/or receive the target ratio via a user interface of controller 22 (e.g., via user input). Controller 22 determines a ratio of catalyst material component to base material component delivered to dispensing device 14 as the ratio of the volumetric flow rate sensed by catalyst flow meter 20A to the volumetric flow rate sensed by base flow meter 20B. Based on the determined ratio of the volumetric flow rates, controller 22 controls operation of one or more of catalyst pump 12A and base pump 12B to produce the target ratio of catalyst material component to base material component delivered to dispensing device 14. Controller 22 controls operation of one or more of catalyst pump 12A and base pump 12B by adjusting a discharge rate of one or more of catalyst pump 12A and base pump 12B to produce the target ratio. Controller 22 can adjust the discharge rate of one or more of catalyst pump 12A and base pump 12B by increasing and/or decreasing a speed of an electric motor that drives the pump to discharge the material component. In some examples, such as when one or more of catalyst pump 12A and base pump 12B is a pressure controlled pump, controller 22 can adjust the discharge rate of the pump by adjusting the pressure of the respective pump.

In some examples, one of catalyst pump 12A and base pump 12B can be configured to deliver material component at a fixed volumetric flow rate. In such an example, controller 22 can control operation of the remaining one of catalyst pump 12A and base pump 12B to adjust the discharge rate of the respective pump to produce the target ratio of catalyst material component and base material component. For instance, catalyst pump 12A can be configured to discharge catalyst material component at a fixed volumetric flow rate. Controller 22, in such an example, controls operation of base pump 12B to adjust (e.g., increase and/or decrease) a discharge rate of base pump 12B to achieve the target ratio of catalyst material component and base material component delivered to dispensing device 14. In other examples, base pump 12B can be configured to discharge base material component at a fixed volumetric flow rate. In such examples, controller 22 controls operation of catalyst pump 12A to adjust (e.g., increase and/or decrease) a discharge rate of catalyst pump 12A to achieve the target ratio of catalyst component and base material component delivered to dispensing device 14. In other examples, controller 22 can control operation of each of catalyst pump 12A and base pump 12B to achieve the target ratio of catalyst material component and base material component delivered to dispensing device 14. For instance, controller 22 can increase a discharge rate of catalyst pump 12A and decrease a discharge rate of base pump 12B in response to determining that a ratio of the sensed volumetric flow rate received from catalyst flow meter 20A to the sensed volumetric flow rate received from base flow meter 20B is less than the target ratio. Controller 22 can decrease a discharge rate of catalyst pump 12A and increase a discharge rate of base pump 12B in response to determining that a ratio of the sensed volumetric flow rate received from catalyst flow meter 20A to the sensed volumetric flow rate received from base flow meter 20B is greater than the target ratio. Accordingly, controller 22 can control operation of one or more of catalyst pump 12A and base pump 12B based on the sensed volumetric flow rates received from catalyst flow meter 20A and base flow meter 20B to produce the target ratio of catalyst material component and base material component at dispensing device 14.

As illustrated in FIG. 1, controller 22 can be electrically and/or communicatively coupled to receive feedback from catalyst pump 12A and base pump 12B. Such feedback can include information relating to a discharge rate of catalyst pump 12A and base pump 12B. Controller 22, in some examples, compares the feedback relating to the discharge rate of catalyst pump 12A and base pump 12B to the volumetric flow rates sensed by catalyst flow meter 20A and base flow meter 20B, respectively, to identify the presence of a failure condition. For example, such as when catalyst pump 12A and base pump 12B are positive displacement rotary gear pumps, controller 22 can receive an indication from each of catalyst pump 12A and base pump 12B identifying a number of revolutions (or partial revolutions) of the respective gears. Controller 22 can determine an estimated volumetric flow rate through each respective one of catalyst pump 12A and base pump 12B based on a defined volumetric flow per revolution (or partial revolution) of the respective gears. Controller 22 can compare the estimated volumetric flow rate for catalyst pump 12A to the volumetric flow rate sensed by catalyst flow meter 20A to produce a catalyst flow difference value. Controller 22 can compare the catalyst flow difference value to a threshold catalyst flow difference value, and can identify the presence of a failure condition associated with one or more of catalyst transfer pump 18A, catalyst pump 12A, catalyst flow meter 20A and/or the fluidic connections there between in response to determining that the catalyst flow difference value exceeds the threshold catalyst flow difference value. Similarly, controller 22 can compare the estimated volumetric flow rate for base pump 12B to the volumetric flow rate sensed by base flow meter 20B to produce a base flow difference value. Controller 22 can compare the base flow difference value to a threshold base flow difference value, and can identify the presence of a failure condition associated with one or more of base transfer pump 18B, base pump 12B, base flow meter 20B and/or the fluid connections there between in response to determining that the base flow difference value exceeds the threshold base flow difference value. The threshold catalyst flow difference value and the threshold base flow difference value can be the same or different value. In some examples, controller 22 outputs an indication of the identified presence of the failure condition, such as via one or more indicator lights, speakers, display devices or other output devices.

Accordingly, a system implementing techniques of this disclosure can increase an accuracy of a ratio of catalyst material component and base material component (as compared with a target ratio) delivered to dispensing device 14. In addition, individual control of each of catalyst pump 12A and base pump 12B based on measured volumetric flow rates from each of catalyst flow meter 20A and base flow meter 20B can enable the system to compensate for flow obstructions or other system variations that can result in variation of the flow rates of one or more of the components delivered to dispensing device 14. Moreover, such individual control of each of catalyst pump 12A and base pump 12B can enable the delivery of multiple target ratios of catalyst material component and base material component without requiring redesign or replacement of the pumps. As such, techniques of this disclosure can increase an accuracy of the ratio of catalyst material component and base material component delivered during operation, as well as the flexibility of the system to accommodate multiple target ratios of the components.

FIG. 2 is a schematic block diagram of fluid dispensing system 28 that controls operation of at least one of a catalyst pump 30A and base pump 30B to produce a target ratio of a catalyst material component and a base material component at dispensing device 14. The example of FIG. 2 is similar to the example of FIG. 1, and same reference numbers are utilized to illustrate same parts. In the example of FIG. 2, rather than utilize transfer pumps 18A and 18B to deliver the catalyst and base material components to catalyst pump 12A and base pump 12B (FIG. 1), fluid dispensing system 28 utilizes catalyst pump 30A and base pump 30B to deliver catalyst material component and base material component directly from catalyst component vessel 16A and base component vessel 16B to dispensing device 14.

Each of catalyst pump 30A and base pump 30B can be positive displacement rotary gear pumps, piston pumps, screw pumps, pressure pumps, or other types of pumps configured to draw fluid from catalyst component vessel 16A and base component vessel 16B, respectively, and deliver the material component under pressure to dispensing device 14. That is, catalyst pump 30A is configured to deliver catalyst material component from catalyst component vessel 16A through catalyst flow meter 20A to dispensing device 14. Base pump 30B is configured to deliver base material component from base component vessel 16B through base flow meter 20B to dispensing device 14.

In operation, controller 22 determines a ratio of catalyst material component to base material component delivered to dispensing device 14 as the ratio of the volumetric flow rate sensed by catalyst flow meter 20A to the volumetric flow rate sensed by base flow meter 20B. Controller 22 controls operation of at least one of catalyst pump 30A and base pump 30B to adjust (e.g., increase and/or decrease) a discharge rate of the respective pump based on the determined ratio of the volumetric flow rates to produce a target ratio of the catalyst material component and base material component delivered to dispensing device 14. Applicator 24 of dispensing device 14 receives each of the catalyst material component and the base material component and provides the two individual components to mixer 26, which mixes the two components during delivery.

Accordingly, controller 22 can automatically control one or more of catalyst pump 30A and base pump 30B to produce a target ratio of catalyst material component and base material component at dispensing device 14. Techniques of this disclosure can therefore increase an accuracy of the ratio of the material components at dispensing device 14 by adjusting the discharge rate of each of catalyst pump 30A and base pump 30B individually to produce the target ratio. Moreover, individual control of the pumps enables delivery of multiple target ratios of the material components, thereby increasing overall usability of the system.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system comprising:
a first pump for delivering a first fluid component;
a second pump for delivering a second fluid component;
a first flow meter configured to sense a first volumetric flow rate of the first fluid component delivered from the first pump;
a second flow meter configured to sense a second volumetric flow rate of the second fluid component delivered from the second pump;
a device for receiving the first fluid component and the second fluid component; and
a controller connected to receive the sensed first volumetric flow rate from the first flow meter and the sensed second volumetric flow rate from the second flow meter, the controller configured to control operation of at least one of the first pump and the second pump based on the sensed first volumetric flow rate and the sensed second volumetric flow rate to produce a target ratio of the first fluid component and the second fluid component at the device.

2. The system of claim 1,
wherein the first pump is configured to deliver the first fluid component at a fixed volumetric flow rate; and
wherein the controller is configured to control operation of the second pump to adjust a discharge rate of the second pump based on the sensed first volumetric flow rate and the sensed second volumetric flow rate to produce the target ratio of the first fluid component and the second fluid component at the device.

3. The system of claim 1,
wherein the controller is configured to control operation of both the first pump and the second pump by adjusting a discharge rate of each of the first pump and the second pump based on the sensed first volumetric flow rate and the sensed second volumetric flow rate to produce the target ratio of the first fluid component and the second fluid component at the device.

4. The system of claim 1,
wherein each of the first pump and the second pump are positive displacement pumps; and
wherein the controller is configured to control operation of at least one of the first pump and the second pump by adjusting a speed of at least one of the first pump and the second pump to produce the target ratio of the first fluid component and the second fluid component at the device.

5. The system of claim 1,
wherein each of the first pump and the second pump are pressure pumps; and
wherein the controller is configured to control operation of at least one of the first pump and the second pump by adjusting a pressure of at least one of the first pump and the second pump to produce the target ratio of the first fluid component and the second fluid component at the device.

6. The system of claim 1, further comprising:
a third pump connected to deliver the first fluid component to the first pump; and
a fourth pump connected to deliver the second fluid component to the second pump.

7. The system of claim 6,
wherein the third pump is configured to deliver the first fluid component to the first pump at a first pressure;
wherein the first pump is configured to deliver the first fluid component to the device at a second pressure that is greater than the first pressure;
wherein the fourth pump is configured to deliver the second fluid component to the second pump at a third pressure; and
wherein the second pump is configured to deliver the second fluid component to the device at a fourth pressure that is greater than the third pressure.

8. The system of claim 1,
wherein the controller is configured to:
receive feedback from each of the first pump and the second pump relating to a discharge rate of each of the first pump and the second pump;
compare the received feedback relating to the discharge rate of the first pump to the volumetric flow rate sensed by the first flow meter to produce a first flow difference value;
compare the received feedback relating to the discharge rate of the second pump to the volumetric flow rate sensed by the second flow meter to produce a second flow difference value; and
identify presence of a failure condition in response to determining that at least one of the first flow difference value and the second flow difference exceeds one or more threshold difference values.

9. The system of claim 1,
wherein the device for receiving comprises a mixer.

10. The system of claim 1,
wherein the first fluid component comprises a catalyst component and the second fluid component comprises a base component.

11. A method comprising:
pumping a first fluid component to a dispensing device from a first pump;
pumping a second fluid component to the dispensing device from a second pump;
measuring a first volumetric flow rate of the first fluid component discharged from the first pump;
measuring a second volumetric flow rate of the second fluid component discharged from the second pump; and
controlling operation of at least one of the first pump and the second pump based on the measured first volumetric flow rate and the measured second volumetric flow rate to produce a target ratio of the first fluid component and the second fluid component at the dispensing device.

12. The method of claim 11,
wherein the first pump is configured to discharge the first fluid component at a fixed volumetric flow rate; and
wherein controlling operation of at least one of the first pump and the second pump comprises controlling operation of the second pump to adjust a discharge rate of the second pump based on the measured first volumetric flow rate and the measured second volumetric flow rate to produce the target ratio of the first fluid component and the second fluid component at the dispensing device.

13. The method of claim 11,
wherein controlling operation of at least one of the first pump and the second pump comprises controlling operation of each of the first pump and the second pump to adjust a discharge rate of each of the first pump and the second pump based on the measured first volumetric flow rate and the measured second volumetric flow rate to produce the target ratio of the first fluid component and the second fluid component at the dispensing device.

14. The method of claim 11,
wherein each of the first pump and the second pump are positive displacement pumps; and
wherein controlling operation of at least one of the first pump and the second pump comprises controlling operation of at least one of the first pump and the second pump to adjust a speed of at least one of the first pump and the second pump to produce the target ratio of the first fluid component and the second fluid component at the dispensing device.

15. The method of claim 11,
wherein each of the first pump and the second pump are pressure pumps; and
wherein controlling operation of at least one of the first pump and the second pump comprises controlling operation of at least one of the first pump and the second pump to adjust a pressure of at least one of the first pump and the second pump to produce the target ratio of the first fluid component and the second fluid component at the dispensing device.

16. The method of claim 11, further comprising:
pumping the first fluid component to the first pump with a third pump; and
pumping the second fluid component to the second pump with a fourth pump.

17. The method of claim 16,
wherein pumping the first fluid component to the first pump with the third pump comprises pumping the first fluid component to the first pump with the third pump at a first pressure;
wherein pumping the first fluid component from the first pump to the dispensing device comprises pumping the first fluid component from the first pump to the dispensing device at a second pressure that is greater than the first pressure;
wherein pumping the second fluid component to the second pump with the fourth pump comprises pumping the second fluid component to the second pump with the fourth pump at a third pressure; and
wherein pumping the second fluid component from the second pump to the dispensing device comprises pumping the second fluid component from the second pump to the dispensing device at a fourth pressure that is greater than the third pressure.

18. The method of claim 11, further comprising:
receiving feedback from each of the first pump and the second pump relating to a discharge rate of each of the first pump and the second pump;
comparing the received feedback relating to the discharge rate of the first pump to the volumetric flow rate sensed by the first flow meter to produce a first flow difference value;
comparing the received feedback relating to the discharge rate of the second pump to the volumetric flow rate sensed by the second flow meter to produce a second flow difference value; and
identifying presence of a failure condition in response to determining that at least one of the first flow difference value and the second flow difference exceeds one or more threshold difference values.

19. The method of claim 11, further comprising:
mixing the first fluid component and the second fluid component at the dispensing device.

20. The method of claim 11,
wherein the first fluid component comprises a catalyst component and the second fluid component comprises a base component.
